(19) United States
(12) Patent Application Publication
(10) Pub. No.: US 2004/0026968 A1
(43) Pub. Date: Feb. 12, 2004

(54) Saddle for training gonadal region

(76) Inventor: Ee Do Kim, Anyang-Si (KR)

Correspondence Address: CANTOR COLBURN LLP, 55 Griffin Road South, Bloomfield, CT, 06002, US

(21) Appl. No.: 10/446,894

(22) Filed: May 28, 2003

(30) Foreign Application Priority Data
Aug. 9, 2002 (KR) 20-2002-0023863

(51) Int. Cl. B62J 1/00

(52) U.S. Cl. 297/201

(57) ABSTRACT

A saddle installed in a bicycle, or a motor cycle, or a health training cycle which is sports equipment, is provided. Muscles in the vicinity of a gonadal region in the human body, are automatically trained when legs are exercised by riding a bicycle or using a health training bicycle. The saddle for training a gonadal region solves problems caused by depression of genitals, and can be widely put into practice as a simple structure. The gonadal region training saddle includes: a safe supporter in which a groove is formed in the front side of the saddle and a combiner whose inner circumferential portion is formed of a screw thread is protrudingly installed at the center of the groove; a cushion member which is united with the upper portion of the safe supporter so as to encompass the edge portion of the safe supporter, in which a hole is formed at a position corresponding to the groove formed in the front side of the safe supporter; an adjustment unit at one side of which a connection rod is formed and at the other side of which a holder is formed, so as to be combined with the combiner of the safe supporter; and a friction unit at the bottom side of which a fitting groove is formed so as to be fitted with the end portion of the connection rod in the adjustment unit.

### BACKGROUND OF THE INVENTION

1. Field of the Invention

The present invention relates to a gonadal region training saddle, and more particularly, to a gonadal region training saddle having a friction unit which easily moves up and down at the upper portion of a saddle mounted in a vehicle which is used as a traffic transportation rider such as a bicycle and a motor cycle, or sports equipment such as a health training bicycle, and for training muscles near a gonadal region such as the testis or penis of a man, when he rides a bicycle or motor cycle or makes an exercise on a health training cycle, to thereby solve a problem caused by depression of genitals.

2. Description of the Related Art

Depression of genitals such as impotency of men frequents. In particular, as men get older, functions of genitals deteriorate greatly. As a result, the sexual life gets troubled and even the desire of life gets lost

Many an implement for training a gonadal region of men has been developed or under development, in order to solve the above problems. A representative implement is an auxiliary implement inserted into the genitals of men by surgical operations, or a non-penetrative implement which is not inserted into genitals of men. However, insertion of the auxiliary implement by the surgical operation causes much cost. Also, a patient may run a risk which may be caused by a surgical operation. The non-penetrative implement is costless, but burdensome in using and managing it.

An exercise implement for men disclosed in Korean Utility Model Laid-open Publication No. 1999-19938, will be described below as an example, which was developed in order to solve the above problems.

The exercise implement for men includes an upper tube whose one end is closed, tubes connected to the upper tube consecutively in a multi-stage, a tube air discharger installed at the one end of the upper tube so as to discharge air from the inside of the tube, a hose of which one end is connected to the tube air discharger, and an air filler connected to the other end of the hose, for decompressing the tube according to contraction and expansion thereof. The exercise implement is characterized in that the upper tube and the multi-stage tubes are combined with adjacent tubes, at a screw portion thereof, and a tightener closely contacts the screw portion in order to adjust of the length of the tube and strengthen the coupling force of the tubes. Also, the exercise implement is characterized in that a protection film which can reciprocate in a lengthy direction of the tube by contact of the male genitals inserted, and a safe operational rod which operates with an interlock with the protection film, for driving a safe pin, are provided in the inside of the upper tube, and a contraction adjustment unit which can automatically adjust contraction is provided in the air filler.

The above-described conventional exercise implement for men can automatically control expansion and contraction of the air filler and opening and closing of the safe pin periodically, maintain a decompression state of the tube by controlling the safe pin timely, and smoothly combine the multi-stage tubes, to thereby provide an effect of increasing a durability. However, the number of the structural elements becomes large to cause an increase in a production cost and a high consumer price. Also, since the strengthened muscles are limited only in the male genitals, the whole problem of depression of genitals cannot be solved. Furthermore, in the case that motors supplying power to the safe pin or the contraction adjustment unit are out of order, even an adverse effect may occur due to a compulsive movement.

Meanwhile, a health training bicycle having a massage implement in the saddle thereof which can be used as a massage unit, was disclosed in Korean Utility Model Laid-open Publication No. 1999-33320.

The health training bicycle includes a support vessel containing a motor, and an eccentric member fitted with the driving axis of the motor, and eccentrically driven by the driving of the motor therein, in which the support vessel is configured at the lower portion of the saddle of the health training bicycle. Here, when the electrically driven motor is activated, the eccentric member fitted with the driving axis of the motor is eccentrically driven to thereby beat the inner portion of the support vessel. In this case, since the saddle combined with the lower portion of the support vessel is vibrated by vibration of the support vessel, the genitals such as the penis of a man can be massaged by the vibrated saddle in the case that he makes an exercise of his legs by using a health training bicycle on which he sits on the saddle thereof.

However, since the eccentric member which eccentrically rotates by the driving force of the motor located in the lower portion of the saddle is worn out due to a repeated use in the case of the health training bicycle having a massage unit, a cost for replacing the eccentric member by a new one is considerable and it is not so easy to replace it.

In addition, many components such as the motor and a power supply supplying power to the motor are needed to thereby cause a high production cost. As a result, its price is so high that the old having no sufficient buying power cannot buy it economically freely.

### SUMMARY OF THE INVENTION

To solve the above problems, it is an object of the present invention to provide a saddle installed in a bicycle, or a motor cycle, or a health training cycle which is sports equipment, in which muscles in the vicinity of a gonadal region in the human body, are automatically trained when legs are exercised by riding a bicycle or using a health training bicycle.

To accomplish the above object of the present invention, there is provided a saddle for training a gonadal region comprises: a safe supporter in which a groove is formed in the front side of the saddle and a combiner whose inner circumferential portion is formed of a screw thread is protrudingly installed at the center of the groove; a cushion member which is united with the upper portion of the safe supporter so as to encompass the edge portion of the safe supporter, in which a hole is formed at a position corresponding to the groove formed in the front side of the safe supporter; an adjustment unit at one side of which a connection rod is formed and at the other side of which a holder is formed, so as to be combined with the combiner of the safe supporter; and a friction unit at the bottom side of which a fitting groove is formed so as to be fitted with the end portion of the connection rod in the adjustment unit.

Preferably, the outer circumferential surface of the connection rod formed at one side of the adjustment unit is formed of screw threads except for the end portions thereof.

The gonadal region training saddle according to the present invention includes a friction unit whose height can be adjusted up and down, and formed in the front side of the saddle mounted in a bicycle, a motor cycle, or a health training bicycle which is a sports implement. Accordingly, the muscles forming the gonadal region are naturally trained by adjusting the height of the friction unit in the process of riding a bicycle or health training bicycle to make an exercise. As a result, a premature ejaculation phenomenon which cannot be self-controlled consciously is prevented. Also, since a striated muscle encompassing the erected cylinder of the penis sponge body forming the base of the penis and the perineum muscle adjacent the striated muscle are trained, depression of genitals such as the impotency or ejaculation disorder is solved.

### BRIEF DESCRIPTION OF THE DRAWINGS

The above and other objects and advantages of the present invention will become more apparent by describing the preferred embodiment thereof in more detail with reference to the accompanying drawings in which:

FIG. 1 is a side view illustrating a bicycle in which a gonadal region training saddle according to the present invention is applied;

FIG. 2 is an exploded perspective view illustrating the structural elements of the gonadal region training saddle according to the present invention;

FIG. 3 is a combined cross-sectional view illustrating the structural elements of the gonadal region training saddle according to the present invention; and

FIG. 4 is a cross-sectional view for explaining a function of a friction unit which is one of the structural elements of the gonadal region training saddle according to the present invention.

### DETAILED DESCRIPTION OF THE INVENTION

A gonadal region training saddle according to the present invention will be described below in detail with reference to the accompanying drawings.

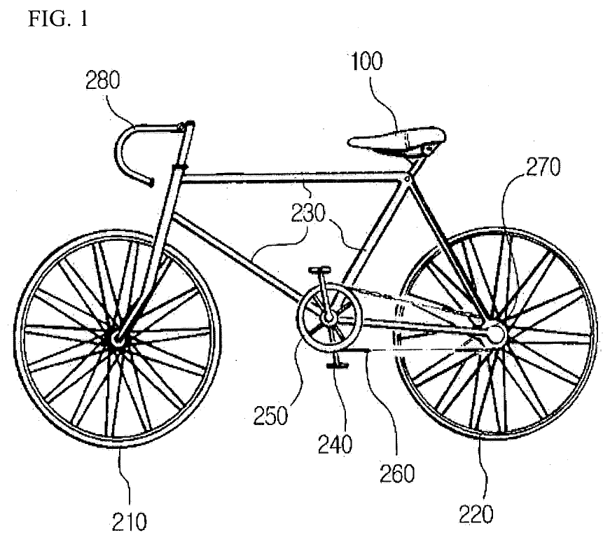

FIG. 1 is a side view illustrating a bicycle in which a gonadal region training saddle according to the present invention is applied. As shown in FIG. 1, a gonadal region training saddle 100 according to the present invention is mounted in the upper portion of a general bicycle including two front and rear wheels 210 and 220, a frame 230 supporting the two front and rear wheels 210 and 230, a front-side sprocket 250 installed through the frame 230, in which pedals 240 are fixed, a rear-side sprocket 270 connected to the front-side sprocket 250 through a chain 260, and installed in the rear wheel 220, and a steering unit 280 installed in the front side of the frame, for steering the front-side wheel.

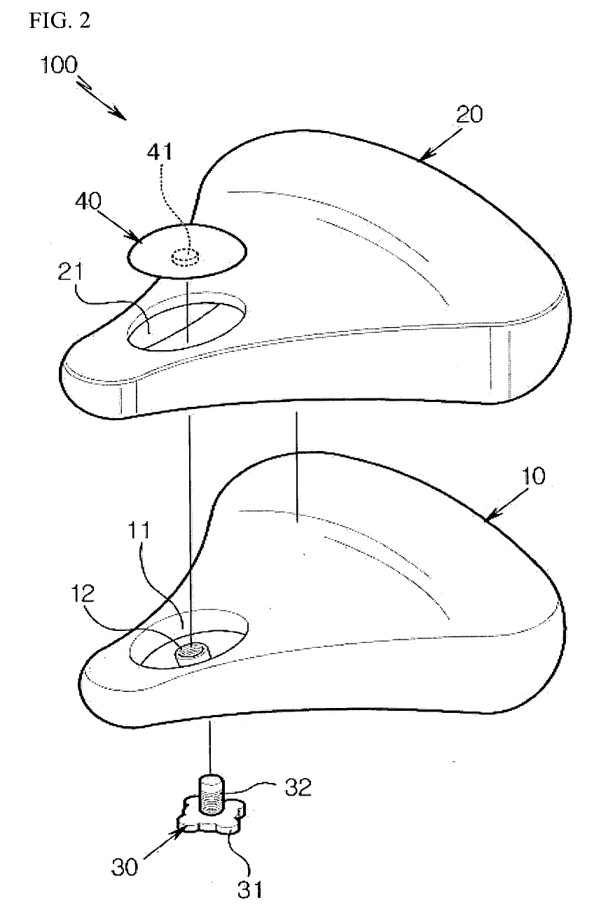

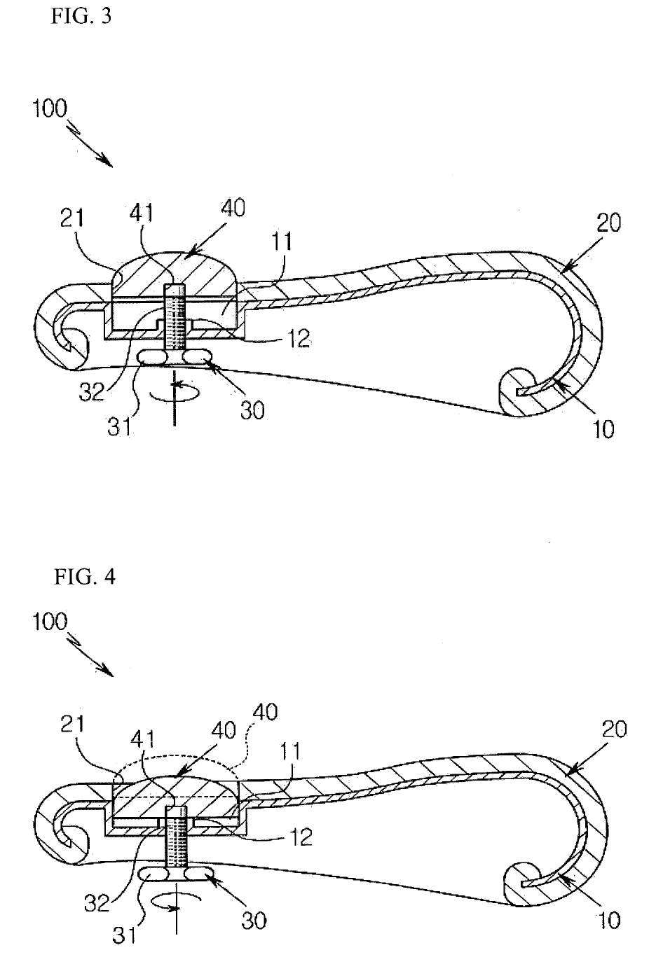

FIG. 2 is an exploded perspective view illustrating the structural elements of the gonadal region training saddle according to the present invention. FIG. 3 is a combined cross-sectional view illustrating the structural elements of the gonadal region training saddle according to the present invention. As shown in FIGS. 2 and 3, the saddle 100 for training a gonadal region includes a safe supporter 10 in which a groove 11 is formed in the front side of the saddle 100 and a combiner 12 is protrudingly installed at the center of the groove 11. A cushion member 20 is united with the upper portion of the safe supporter 10 so as to encompass the edge portion of the safe supporter 10, in which a hole 21 is formed at a position corresponding to the groove 11 formed in the front side of the safe supporter 10. An adjustment unit 30 at one side of which a connection rod 32 is formed and at the other side of which a holder 31 is formed, is combined with the combiner 32 of the safe supporter 10, in which the connection rod 32 protrudes from the upper portion of the combiner 12. A friction unit 40 at the bottom side of which a fitting groove 41 is formed is fitted with the end portion of the connection rod 32 in the adjustment unit 30 protruding from the upper portion of the combiner 12. The friction unit 40 is positioned in the groove 11 in the safe supporter 10 through the hole 21 in the cushion member 20.

Preferably, the outer circumferential surface of the connection rod 32 formed at one side of the adjustment unit 30 is formed of screw threads except for the end portions thereof, in order to make the adjustment unit 30 easily ascend and descend when the height of the friction unit 30 has been adjusted.

In the case of the gonadal region training saddle 100 according to the present invention, a user adjusts the protruding height of the friction unit 40 fitted into the connection rod 32 in the adjustment unit 30 by turning the adjustment unit 30 prior to riding a bicycle in which the saddle 100 is applied. Then, when the user is seated on the saddle and repeatedly runs pedals by use of his legs, the globular body of the urethra sponge body which forms the base of the penis, muscles forming the gonadal region such as the striated muscles encompassing the erected cylinder of the penis sponge body forming the base of the penis and the perineum muscles adjacent the striated muscle are trained.

That is, since the hips move to the left and right by movement of the legs in the process of operating the pedals, the muscles formed near the gonadal region of men also moves to the left and right. Accordingly, the gonadal region of the man is frictionally rubbed against the friction unit 40 protruding at the front-side of the saddle 100, to the left and right. As a result, the muscles in the vicinity of the gonadal region are trained.

FIG. 4 is a cross-sectional view for explaining a function of a friction unit which is one of the structural elements of the gonadal region training saddle according to the present invention.

Also, in the case that a user does not wish to train the muscles in the gonadal region, the adjustment unit 30 is manipulated to make the friction unit 40 protruding at the front side of the cushion member 20 which forms the saddle 100 descend. As shown in FIG. 4, after the friction unit 40 has descended into the groove 11 located at the front side of the safe supporter 10, the user can ride the bicycle.

Thus, the bicycle in which the gonadal region training saddle according to the present invention is mounted, can be available to women as well as men who desire to train their gonadal region, which does not limit to users who ride it.

Also, the shape of the friction unit has been illustrated as a circular shape, but is not limited thereto. Accordingly, the friction unit, the groove in the safe supporter into which the friction unit is inserted, and the hole in the cushion member are embodied in an identical form, and can be modified in various forms if they are identically shaped.

Further, a material of the friction unit contained in the gonadal region training saddle according to the present invention is preferably made of rubber which would not compress the gonadal region excessively but is not limited thereto.

As described above, the gonadal region training saddle according to the present invention can be configured in a simple structure and thus can be widely applied to implements each needing a saddle. Also, since the protruding degree of the friction unit can be adjusted, the bicycle where the gonadal region training saddle according to the present invention is applied can be used for women as well as men. For men, the muscles forming the gonadal region can be trained while riding the bicycle. Thus, depression of genitals such as premature ejaculation, ejaculation disorder and impotency can be solved. In particular, the old who cannot live a smooth sexual life because of a weak muscle force can maintain a vivid sexual life after having trained the muscles with a bicycle which employs the gonadal region training saddle according to the present invention.

What is claimed is:

1. A saddle for training a gonadal region comprises:
a safe supporter in which a groove is formed in the front side of the saddle and a combiner whose inner circumferential portion is formed of a screw thread is protrudingly installed at the center of the groove;
a cushion member which is united with the upper portion of the safe supporter so as to encompass the edge portion of the safe supporter, in which a hole is formed at a position corresponding to the groove formed in the front side of the safe supporter;
an adjustment unit at one side of which a connection rod is formed and at the other side of which a holder is formed, so as to be combined with the combiner of the safe supporter; and
a friction unit at the bottom side of which a fitting groove is formed so as to be fitted with the end portion of the connection rod in the adjustment unit.

2. The gonadal region training saddle of claim 1, wherein the outer circumferential surface of the connection rod formed at one side of the adjustment unit is formed of screw threads except for the end portions thereof.
